(19) United States
(12) Patent Application Publication
(10) Pub. No.: US 2026/0370494 A1
(43) Pub. Date: Nov. 19, 2026

(54) PROCESSING RIGHT TRANSFER SYSTEM AND PROCESSING RIGHT TRANSFER METHOD

(71) Applicant: Hitachi, Ltd., Chiyoda-ku, Tokyo (JP)

(72) Inventors: Yukie MOTOMIYA, Tokyo (JP); Kenta TAKAHASHI, Tokyo (JP); Ken NAGANUMA, Tokyo (JP); Wataru NAKAMURA, Tokyo (JP); Non KAWANA, Tokyo (JP); Takayuki HABUCHI, Tokyo (JP)

(21) Appl. No.: 19/111,740

(22) PCT Filed: Sep. 29, 2023
(86) PCT No.: PCT/JP2023/035633

§ 371 Date: Jan. 16, 2026

(30) Foreign Application Priority Data
Oct. 5, 2022 (JP) 2022-161248

(51) Int. Cl. H04L 9/32; H04L 9/30

(52) U.S. Cl. CPC H04L 9/3268; H04L 9/30; H04L 9/3231; H04L 9/3236; H04L 9/3247

(57) ABSTRACT

A processing right transfer system comprises: a first terminal; and an implementation subject, the first terminal holds a first certificate based on biometric information about a processing entrustor and indicating: an implementation condition and an implementation content of processing; and an identifier of a transferee of a processing right, the implementation subject transmits information indicating whether the implementation condition is fulfilled and its identifier to the first terminal, the first terminal: determines, if it is determined in first certificate verification and based on the information received from the implementation subject that there is an implementation subject having transmitted the information on fulfillment of the implementation condition, whether an identifier of the determined implementation subject conforms to the identifier in the first certificate; and transfers, to the implementation subject, the right to perform the processing indicated by the implementation content, based on result of the first certificate verification.

### CLAIM OF PRIORITY

The present application is a national phase application of PCT/JP 2023/035633 filed on Sep. 29, 2023 which claims priority from Japanese patent application JP 2022-161248 filed on Oct. 5, 2022, the content of which is hereby incorporated by reference into this application.

### BACKGROUND OF THE INVENTION

The present invention is related to a processing right transfer system and a processing right transfer method.

Background techniques of the present technical field are shown in Japanese Unexamined Patent Publication No. 2018-14622 (Patent Document 1) and Japanese Unexamined Patent Publication No. 2013-123142 (Patent Document 2).

Patent Document 1 states that “a signature verification system for verifying a signature using a computer equipped a processor and a memory, and the signature verification system comprises: a biometric information acquiring unit for acquiring biometric information of a user; a public template certificate generating unit for generating a public template certificate by applying predetermined processing to the biometric information; a key pair generating unit for generating a pair of a secret key and a public key; a public key certificate generating unit for generating a public key certificate by adding a biometric signature to the public key using the biometric information as a key; and a verifying unit for accepting a transaction including the public template certificate, the public key certificate, and the signature, verifying the validity of the public key certificate with the public template certificate, and verifying the signature with the public key certificate” (see Abstract).

Patent Document 2 states that “at the time of registration, a predetermined secret key is embedded in a feature quantity of biometric information about a user, and the secret key is paired with a corresponding public key to issue a biometric certificate. At the time of adding a signature, a pair of a temporary secret key and a temporary public key is newly generated in response to a signature feature quantity of the biometric information about the user, a signature responsive to a message is generated using the temporary secret key, the temporary secret key is embedded in the signature feature quantity to generate a commitment, and a group of the temporary public key, the signature, and the commitment is defined as a biometric signature. At the time of verifying the biometric signature, the signature is verified with the temporary public key, and a differential secret key and a differential public key are generated from the biometric certificate, the commitment, and the temporary public key to verify correspondence” (see abstract).

### PRIOR ART DOCUMENTS

### Patent Documents

Patent Document 1: Japanese Unexamined Patent Publication No. 2018-14622
Patent Document 2: Japanese Unexamined Patent Publication No. 2013-123142

### SUMMARY OF THE INVENTION

According to the technique stated in Patent Document 1, if verification of a transaction based on verification result about the public template certificate or verification result about the public key certificate has succeeded, the transaction is approved. However, the public template certificate or the public key certificate does not define a condition for approving the transaction, an implementation content of processing to be performed when the transaction is approved, etc., so that processing not intended by a user might be performed. Information defining such a condition or such an implementation content is also absent in Patent Document 2.

Thus, one aspect of the present invention is to prevent processing not intended by an entrustor from being performed by an implementation subject.

In order to solve the above problems, the one aspect of the present invention adopts the following structures. A processing right transfer system comprises: a first terminal; and an implementation subject to perform processing, the first terminal holds a first certificate indicating an entrustment content and an identifier of a transferee implementation subject to which a right to perform the processing is to be transferred, the entrustment content indicating an implementation condition for the processing and an implementation content of the processing, the first certificate being based on biometric information about an entrustor of the processing, the implementation subject transmits information indicating whether the implementation condition is fulfilled and the identifier of the implementation subject to the first terminal, and the first terminal: conducts first certificate verification based on the entrustment content and the identifier indicated by the first certificate; determines, if the first terminal determines in the first certificate verification and on the basis of the information received from the implementation subject that there is an implementation subject having transmitted the information indicating that the implementation condition is fulfilled, whether an identifier of the determined implementation subject conforms to the identifier indicated by the first certificate; and transfers, to the implementation subject, the right to perform the processing indicated by the implementation content, on the basis of result of the first certificate verification.

The one aspect of the present invention can prevent processing not intended by an entrustor from being performed by an implementation subject.

Problems, configurations, and effects which are not mentioned above are explained in the following embodiments.

### BRIEF DESCRIPTION OF THE DRAWINGS

The present invention can be appreciated by the description which follows in conjunction with the following figures, wherein:

FIG. 1 is a block diagram showing an example of configuration of a processing right transfer system according to the First Embodiment;

FIG. 2 is a flowchart showing a processing procedure of initial registration of an entrustor template certificate according to the First Embodiment;

FIG. 3 is a flowchart showing a specific procedure of the initial registration according to the First Embodiment;

FIG. 4A is a flowchart showing an example of right transfer processing according to the First Embodiment;

FIG. 4B a flowchart showing an example of right transfer processing is according to the First Embodiment;

FIG. 5 is a flowchart showing exemplary details of device certificate verification processing according to the First Embodiment;

FIG. 6 is a flowchart showing exemplary details of entrustor template certificate verification processing according to the First Embodiment;

FIG. 7A is a diagram showing an example of data configuration of a device certificate according to the First Embodiment;

FIG. 7B is a diagram showing an example of data configuration of an entrustor template certificate according to the First Embodiment;

FIG. 8 is a block diagram showing an exemplary hardware configuration of an IoT terminal, a verification terminal, an entrustor template repository in the processing right transfer system according to the First Embodiment;

FIG. 9 is a flowchart showing an example of verification processing by the verification terminal according to the First Embodiment;

FIG. 10 is an explanatory view showing an exemplary outline of entire processing by the processing right transfer system according to the First Embodiment;

FIG. 11A is an explanatory view showing an exemplary entrustment right of an entrustor according to the Second Embodiment; and

FIG. 11B is an explanatory view showing an exemplary entrustment right of an entrustor according to the Second Embodiment.

### DETAILED DESCRIPTION OF THE EMBODIMENTS

In the following, embodiments of the present invention are explained referring the attached drawings. In the embodiments, the same configuration has the same reference letter, and repeated explanation are omitted. Note that the embodiments are examples to achieve the present invention and do not limit a technical range of the present invention.

### First Embodiment

In the present embodiment, after an attribute of an entrustor, a signature of a senior of the entrustor and others are verified and after verification such as that conducted to see whether a condition for performing processing is fulfilled, the entrustor transfers a processing right to a device/app and the device/app having received the transferred processing right performs the processing autonomously.

A procedure will be described below by referring to the drawings.

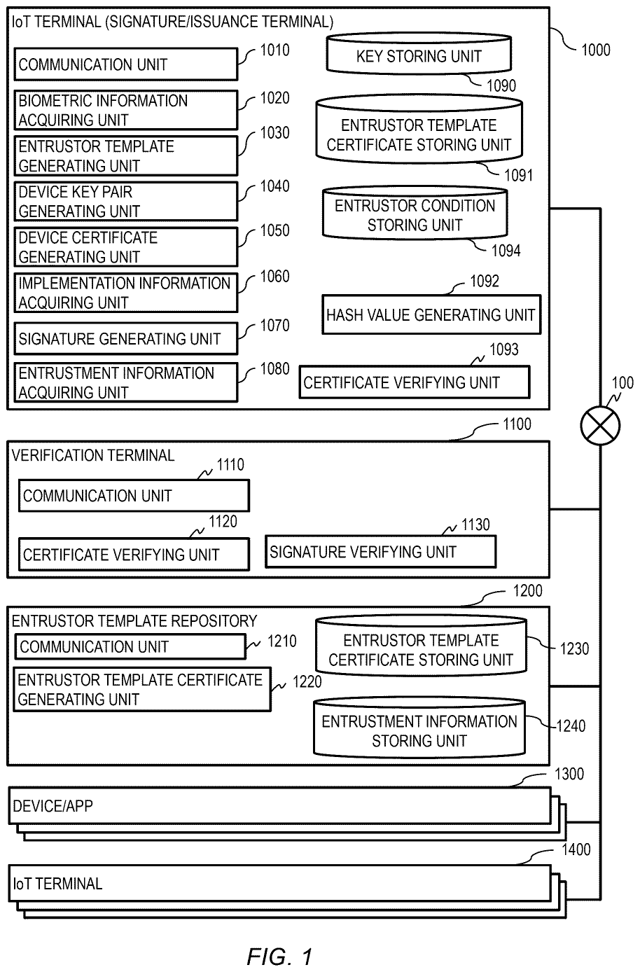

FIG. 1 is a block diagram showing an example of the configuration of a processing right transfer system. The processing right transfer system includes an IoT (Internet of Things) terminal 1000 (an example of a first terminal) having functions as a signature terminal and an issuance terminal, a verification terminal 1100 (an example of a second terminal), an entrustor template repository 1200, one or more devices/apps 1300, and one or more IoT terminals 1400 that are connected to each other via a network 100 such as the Internet.

In this drawing, the IoT terminal 1000 includes a communication unit 1010, a biometric information acquiring unit 1020, an entrustor template generating unit 1030, a device key pair generating unit 1040, a device certificate generating unit 1050, an implementation information acquiring unit 1060, a signature generating unit 1070, an entrustment information acquiring unit 1080, a key storing unit 1090, an entrustor template certificate storing unit 1091, a hash value generating unit 1092, a certificate verifying unit 1093, and an entrustor condition storing unit 1094.

The communication unit 1010 makes communication with the verification terminal 1100, the entrustor template repository 1200, the device/app 1300, and the IoT terminal 1400 via the network 100.

The biometric information acquiring unit 1020 acquires biometric information such as a fingerprint, a vein, and/or a face image from a user via a fingerprint sensor, a vein sensor, and/or a camera, for example. A fingerprint sensor, a vein sensor, or a camera of a mobile phone or a smartphone are available as a sensor for acquiring the biometric information.

The entrustor template generating unit 1030 generates an entrustor template as a public template by applying unidirectional (irreversible) conversion to the biometric information acquired by the biometric information acquiring unit 1020 in accordance with the method of Patent Document 2. Publicly-known or well-known conversion processing is applicable as the unidirectional conversion.

The device key pair generating unit 1040 generates a pair of a device secret key and a device public key using publicly-known or well-known public key cryptography (such as RSA or DSA (Digital Signature Algorithm)). The pair of the device secret key and the device public key is generated for each device/app 1300. When the device/app 1300 having received a transferred processing right performs processing, a signature using the device secret key corresponding to this device/app 1300 is added to implementation information described later. Furthermore, this signature is verified using the device public key corresponding to this device secret key.

The device certificate generating unit 1050 generates a device certificate (an example of a first certificate) as a public key certificate by adding a biometric signature using the biometric information acquired by the biometric information acquiring unit 1020 as a key to the device public key generated by the device key pair generating unit 1040.

The implementation information acquiring unit 1060 acquires implementation information through input from an input device or receipt from another system, for example. The implementation information indicates an implementation content as a content of processing to be performed by the device/app 1300, for example.

The entrustment information acquiring unit 1080 acquires entrustment information. For example, the entrustment information indicates information about an identifier of an entrustor to transfer a processing right to the device/app 1300, an attribute of the entrustor, and a senior of the entrustor (if necessary), an expiration date of an entrustor template certificate, a serial number of the device/app 1300 to which the processing right is to be transferred, an entrustment content (including an implementation condition for corresponding processing and an implementation content of this processing, for example), an expiration date of the device certificate, and others.

The key storing unit 1090 stores the device secret key and the device certificate. The entrustor template certificate storing unit 1091 stores an entrustor template certificate (an example of a second certificate) generated by an entrustor template certificate generating unit 1220 of the entrustor template repository 1200 described later.

The hash value generating unit 1092 generates a hash value by inputting the implementation information acquired by the implementation information acquiring unit 1060 or other information to a predetermined hash function.

The signature generating unit 1070 generates a signature value using the device secret key for the hash value generated by the hash value generating unit 1092.

The certificate verifying unit 1093 verifies the entrustor template certificate generated by the entrustor template certificate generating unit 1220 and the device certificate generated by the device certificate generating unit 1050.

The entrustor condition storing unit 1094 stores an entrustor condition defined in advance. The entrustor condition indicates an attribute of an entrustor allowed to transfer a processing right to the device/app 1300, for example. The attribute of the entrustor allowed to transfer the processing right indicated by the entrustor condition may be defined for each device/app 1300, for each implementation content, or for each combination of the device/app 1300 and the implementation content. A list of identifiers of entrustors allowed to transfer the processing right to the device/app 1300 may be described as the entrustor condition. The entrustor condition may be stored in the entrustor template repository 1200 instead of or in addition to being stored in the IoT terminal 1000.

Next, the verification terminal 1100 has a configuration including a communication unit 1110, a certificate verifying unit 1120, and a signature verifying unit 1130.

After a processing right is transferred to the device/app 1300 (or after processing is performed by the device/app 1300), for example, the certificate verifying unit 1120 verifies the entrustor template certificate generated by the entrustor template certificate generating unit 1220 and the device certificate generated by the device certificate generating unit 1050.

After a processing right is transferred to the device/app 1300 (or after processing is performed by the device/app 1300), for example, the signature verifying unit 1130 verifies each type of signature.

The communication unit 1110 makes communication with the IoT terminal 1000, the entrustor template repository 1200, the device/app 1300, and the IoT terminal 1400 via the network 100.

The verification terminal 1100 is desirably managed by an organization different from an organization to which the IoT terminal 1000, the device/app 1300, and the IoT terminal 1400 belong. Specifically, by verifying each type of certificate and each type of signature using the verification terminal 1100, the validity of processing (procedure) is verified by a third party having received result of the processing.

Next, the entrustor template repository 1200 has a configuration including a communication unit 1210, the entrustor template certificate generating unit 1220, an entrustor template certificate storing unit 1230, and an entrustment information storing unit 1240.

The entrustor template certificate generating unit 1220 generates an entrustor template certificate from the entrustor template generated by the entrustor template generating unit 1030 of the IoT terminal 1000.

The entrustor template certificate storing unit 1230 stores the entrustor template certificate generated by the entrustor template certificate generating unit 1220.

The entrustment information storing unit 1240 stores the entrustment information acquired, for example, by the entrustment information acquiring unit 1080 of the IoT terminal 1000.

The communication unit 1210 makes communication with the IoT terminal 1000, the verification terminal 1100, the device/app 1300, and the IoT terminal 1400 via the network 100.

The device/app 1300 is a subject to receive transfer of a processing right and perform processing based on the transferred processing right. The device of the device/app 1300 may be united with either the IoT terminal 1000 or the IoT terminal 1400. The app of the device/app 1300 may be installed on either the IoT terminal 1000 or the IoT terminal 1400. Specifically, either the IoT terminal 1000 or the IoT terminal 1400 itself may be a subject to receive transfer of a processing right and perform processing based on the transferred processing right.

While illustration of the configuration of IoT terminal 1400 is omitted from the drawings, this configuration is the same as that of the IoT terminal 1000, for example.

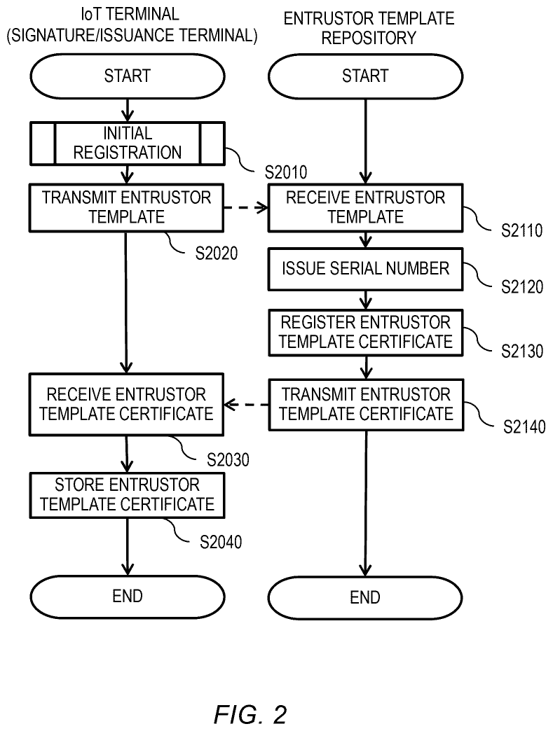

FIG. 2 is a flowchart showing a processing procedure of initial registration of an entrustor template certificate. This processing is to cause the IoT terminal 1000 to acquire biometric information from a user and cause the entrustor template repository 1200 to generate the entrustor template certificate. Each procedure will be described below.

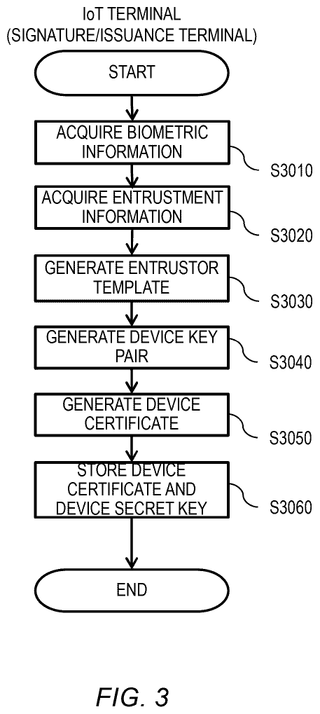

The IoT terminal 1000 conducts the initial registration (S2010). A specific procedure of the initial registration will be described later by referring to FIG. 3. An entrustor template is generated by this procedure.

The IoT terminal 1000 transmits the entrustor template to the entrustor template repository 1200 (S2020). In doing this, the IoT terminal 1000 simultaneously transmits information necessary for generating the entrustor template certificate such as a user name, a biometric signature algorithm used for generating the entrustor template, and at least a part of entrustment information (information about an identifier of an entrustor to transfer a processing right to the device/app 1300, an attribute of the entrustor, and a senior of the entrustor, and information including an expiration date of the entrustor template, for example). In order to prevent tampering, a biometric signature may be added to these pieces of information.

The entrustor template repository 1200 receives the entrustor template (S2110), and issues a serial number for the received entrustor template (S2120). The serial number is a number added uniquely to the entrustor template and is managed by the entrustor template repository 1200 in a manner avoiding duplication thereof.

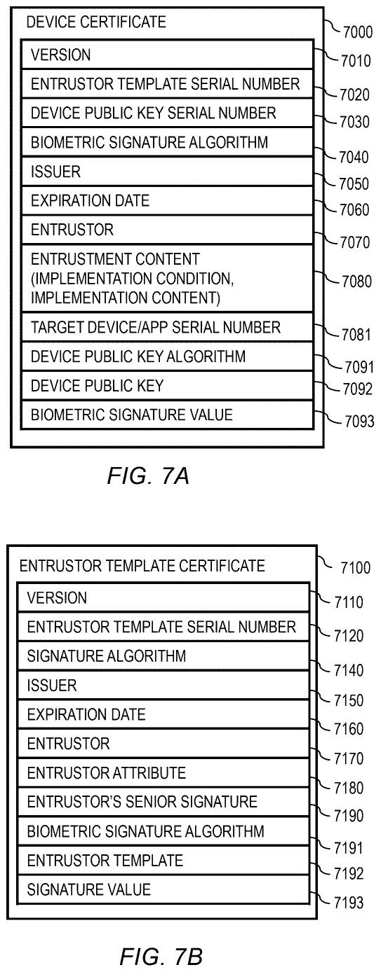

The entrustor template repository 1200 adds a signature to the entrustor template, generates an entrustor template certificate, and registers the entrustor template certificate with the entrustor template certificate storing unit 1230 (S2130). The entrustor template is given the information indicating the identifier of the entrustor and the attribute of the entrustor, the expiration date, and others. The entrustor template may further be given a signature of the senior of the entrustor (such as a biometric signature generated by an arbitrary signature algorithm, for example). A data configuration of the entrustor template certificate will be described later by referring to FIG. 7B. The entrustor template repository 1200 stores at least a part of the entrustment information received from the IoT terminal 1000 into the entrustment information storing unit 1240.

In the first embodiment, it is assumed that the entrustor template repository 1200 functions as a trustable third-party organization so injustice is not to be done.

For this reason, the signature to be added to the entrustor template is generated using a secret key of a certificate authority stored in the entrustor template repository 1200, for example. This makes it difficult for a third party not having the secret key of the certificate authority to generate an entrustor template certificate, so that it becomes possible to prevent the occurrence of impersonation and the like due to issuance of an unauthorized entrustor template certificate.

The entrustor template repository 1200 transmits the entrustor template certificate generated in step S2130 to the IoT terminal 1000 (S2140). The IoT terminal 1000 receives the entrustor template certificate (S2030).

The IoT terminal 1000 stores the entrustor template certificate received in step S2030 into the entrustor template certificate storing unit 1091 (S2040). By causing the IoT terminal 1000 to hold the entrustor template certificate in this way, it becomes possible for the IoT terminal 1000 to transmit the entrustor template certificate to the verification terminal 1100 after implementation of processing by the device/app 1300 having received the transferred processing right. This eventually allows verification of the entrustor template certificate even in a situation where the verification terminal 1100 is not accessible to the entrustor template repository 1200, as will be described later.

In this way, the initial registration of the entrustor template certificate is completed.

A specific procedure of the initial registration processing performed in step S2010 in FIG. 2 will be described next by referring to FIG. 3.

The biometric information acquiring unit 1020 of the IoT terminal 1000 acquires biometric information about the entrustor (an administrator, an owner, or a user of the IoT terminal 1000, for example) (S3010). A biometric sensor such as a fingerprint sensor, a vein sensor, or a camera is connected to the IoT terminal 1000, and the biometric information acquiring unit 1020 acquires biometric information such as a fingerprint, a vein, or a face image of the entrustor using such a sensor.

The entrustment information acquiring unit 1080 acquires the entrustment information through input to an input device of the IoT terminal 1000, for example (S3020).

The entrustor template generating unit 1030 generates the entrustor template as a public template (S3030) by applying unidirectional conversion to the biometric information about the entrustor acquired in step S3010. For this conversion, a biometric encryption method is adopted by which error included in the biometric information is corrected to generate unique data, and encryption processing is performed using the resultant data as a key. Examples of a method available for this conversion include Fuzzy Commitment, Fuzzy Vault, and the biometric signature disclosed in Patent Document 2. The following description will be given on the assumption that the biometric signature disclosed in Patent Document 2 is used.

According to the biometric signature, the unidirectional conversion is applied to the biometric information to generate the public template (the entrustor template of the present embodiment). Even if the public template (the entrustor template of the present embodiment) is acquired by a third party, it is still considerably difficult to decrypt the biometric information. Thus, like a public key, the public template can be handled as public information.

The device key pair generating unit 1040 of the IoT terminal 1000 generates a device key pair composed of a device secret key and a device public key (S3040). The device key pair is generated on the basis of publicly-known or well-known public key cryptography such as RSA encryption, DSA encryption, or Elgamal encryption.

The device certificate generating unit 1050 of the IoT terminal 1000 generates a device certificate (S3050) by adding a biometric signature using the biometric information about the entrustor acquired in step S3010 as a key to the device public key obtained in step S3040. Furthermore, the device certificate is given at least a part of the entrustment information (such as the identifier of the entrustor to transfer the processing right to the device/app 1300, a serial number of the device/app 1300 to which the processing right is to be transferred, a content of processing to be entrusted (an implementation condition for the processing and an implementation content of the processing), an expiration date of the device certificate, and others). A data configuration of the device certificate will be described later by referring to FIG. 7A.

The IoT terminal 1000 associates the device secret key generated in step S3040 and the device certificate generated in step S3050 with each other, and stores the same into the key storing unit 1090 (S3060).

In this way, the device key pair and the device certificate are generated to complete the initial registration processing in step S2010.

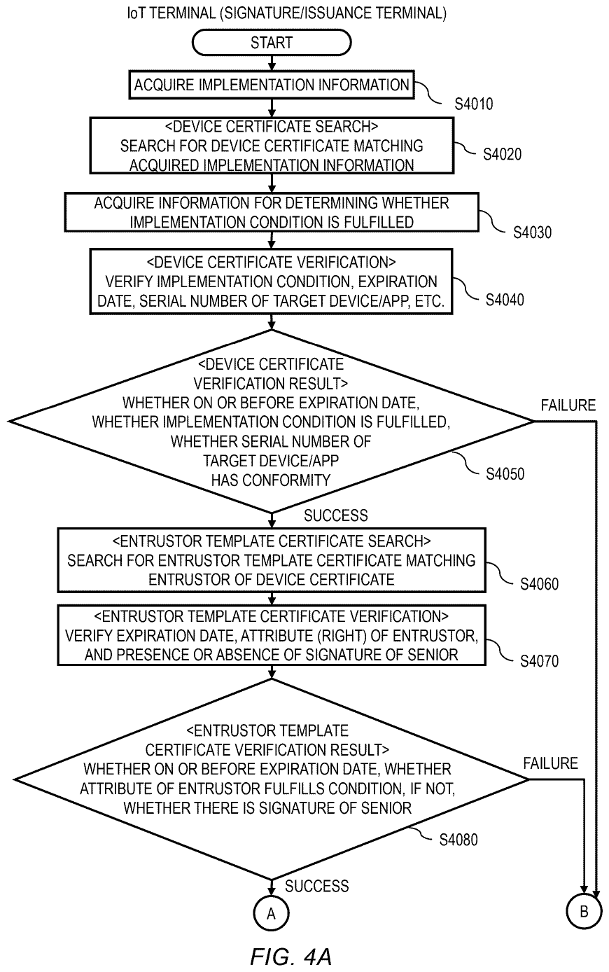

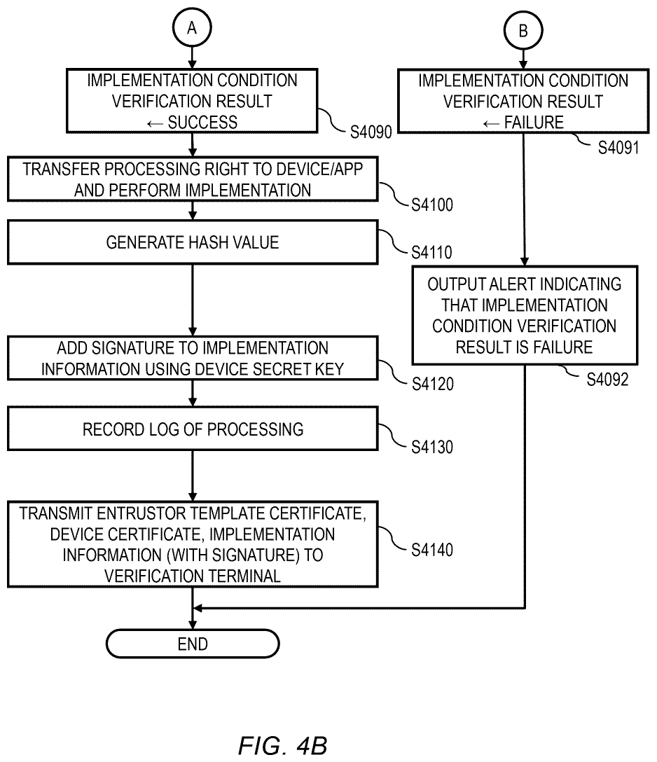

FIGS. 4A and 4B are flowcharts showing an example of right transfer processing. This processing may be performed regularly or may be started in accordance with an instruction from a user of the IoT terminal 1000, for example.

The implementation information acquiring unit 1060 of the IoT terminal 1000 acquires implementation information in accordance with input from the input device, for example (S4010).

The certificate verifying unit 1093 searches for and acquires a device certificate from the key storing unit 1090 (S4020) that corresponds to the implementation information acquired in step S4010. The implementation information indicates an implementation content of processing to be performed by the device/app 1300, for example, and the implementation content is stored as a part of an entrustment content in the device certificate. Thus, the device certificate including the implementation content indicated by the implementation information acquired in step S4010 is acquired in step S4020. The implementation information may further indicate information for searching for the device certificate (such as the identifier of the entrustor or the serial number of the device/app 1300, for example), which is information different from the implementation content.

The certificate verifying unit 1093 identifies an implementation condition in the entrustment content from the device certificate acquired in step S4020, and acquires information for determining whether the identified implementation condition is fulfilled (S4030). The implementation condition is defined by an internal factor such as an internal state of the device/app 1300 or processing having been performed by the device/app 1300 and/or an external factor such as an environment to which the device/app 1300 belongs or a state of a target to be processed by the device/app 1300, and others. For this reason, in step S4030, the certificate verifying unit 1093 transmits a request via the communication unit 1010 for acquiring such information from a plurality of the predetermined devices/apps 1300 (from all the devices/apps 1300, for example), and receives a reply from each of these devices/apps 1300 including such information and a device/app serial number of each device/app 1300, for example.

If the acquired device certificate defines a power trading system as the device/app 1300, defines a power price of being equal to or greater than a predetermined value as the implementation condition, and defines selling of power as the implementation content, for example, the certificate verifying unit 1093 acquires a power price from an external power price monitoring system, for example, as information for determining whether this implementation condition is fulfilled. A method of acquiring the information for determining whether the implementation condition is fulfilled may be determined in advance for each implementation condition or may be described as a part of the entrustment content included in the device certificate.

The certificate verifying unit 1093 verifies the device certificate (S4040) acquired in step S4020. The device certificate includes an expiration date 7060 of the device certificate, an entrustment content 7080 (including an implementation condition and an implementation content), and a target device/app serial number 7081, which will be described later by referring to FIG. 7A. According to this procedure, the certificate verifying unit 1093 verifies whether the device certificate is on or before the expiration date, whether the implementation condition is to be fulfilled, whether a serial number of a device/app conforming to a serial number of the target device/app 1300 has been acquired, and others.

By doing so, it becomes possible to cause the proper device/app 1300 to perform processing that is described in the device certificate on or before the expiration date, fulfills the implementation condition, and is in line with the implementation content. This eventually makes it possible to prevent implementation of processing not intended by the entrustor (an administrator or an owner of the IoT terminal 1000, for example).

The device certificate is given the biometric signature in step S3050 using the biometric information as a key. In step S4040, the certificate verifying unit 1093 may further perform processing for verifying validity using the entrustor template certificate to judge whether this biometric signature has actually been added by the identical person. As a result of the verification, it becomes possible for the verification terminal 1100 to verify that a user having generated the entrustor template certificate and a user having generated the device certificate are identical. As an example, a user having generated the entrustor template certificate included in an existing transaction and a user having generated the device certificate are the entrustor (an owner, an administrator, or a user of the IoT terminal 1000, for example). Specifically, in the present embodiment, conducting this verification shows that implementation of valid processing is entrusted by a valid entrustor.

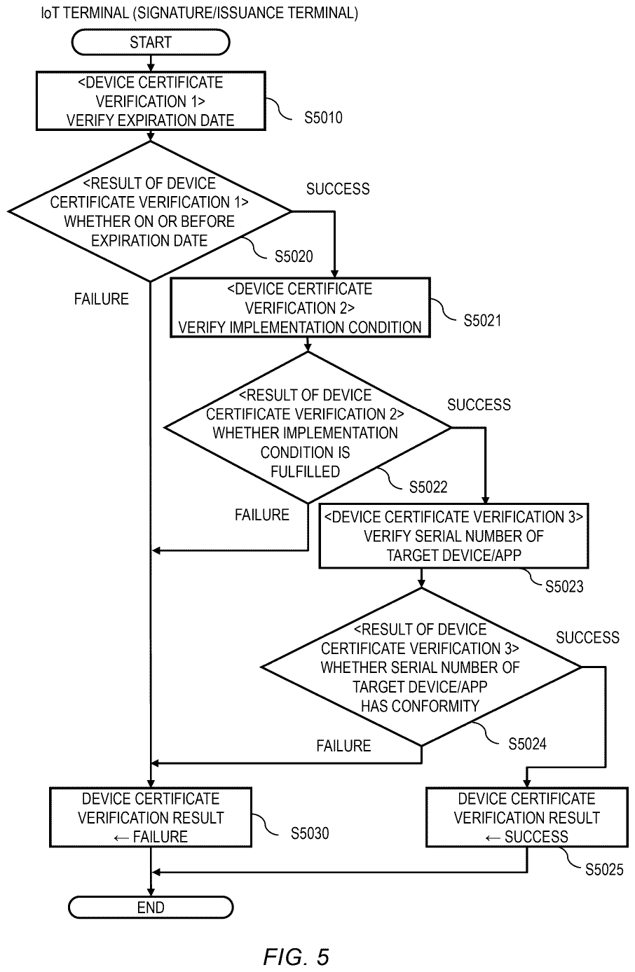

The certificate verifying unit 1093 performs a conditional branch (S4050) on the basis of result of the verifications in step S4040. If all the verifications conducted in step S4040 have succeeded, the certificate verifying unit 1093 proceeds to processing from step S4060 onwards. If these verifications have failed, the certificate verifying unit 1093 substitutes failure into implementation condition verification result (S4091). Details of the processing in step S4040 and those of the processing in step S4050 will be described later using FIG. 5. If the processing in step S4091 is performed, the certificate verifying unit 1093 makes a notification to the entrustor by outputting an alert indicating that the implementation condition verification result is the failure to an output device of the IoT terminal 1000 (S4092), and finishes the right transfer processing. If the processing in step S4091 is performed (if the failure is substituted into the implementation condition verification result), the certificate verifying unit 1093 may record a log of entrustor template certificate verification processing and a log of device certificate verification processing (a log of the entrustor template certificate verification processing is not recorded if the entrustor template certificate verification processing is not performed), and may hold the log in the IoT terminal 1000.

The certificate verifying unit 1093 searches for and acquires an entrustor template certificate from the entrustor template certificate storing unit 1091 (S4060) that matches an entrustor indicated by the device certificate acquired in step S4020 (the device certificate and the entrustor template certificate store an identifier of the entrustor).

The certificate verifying unit 1093 verifies the entrustor template certificate (S4070) acquired in step S4060. The entrustor template certificate includes an expiration date 7160 of the entrustor template certificate, an entrustor attribute 7180, and an entrustor's senior signature 7190 (if necessary), which will be described later by using FIG. 7B. According to this procedure, the certificate verifying unit 1093 verifies whether the entrustor template certificate is on or before an expiration date, whether an attribute of the entrustor fulfills an entrustor condition, whether a signature of a senior of the entrustor is added if the attribute of the entrustor does not fulfill the entrustor condition, and others.

By doing so, it becomes possible to verify that the entrustor template on or before the expiration date has been generated under a valid right (specifically, the entrustor template has been generated by an entrustor having a valid right or has been approved by a senior having a valid right).

The entrustor template certificate is given a signature value generated in step S2130 using the secret key of the certificate authority. In step S4070, the certificate verifying unit 1093 may further perform processing for verifying this signature value using the public key of the certificate authority. As a result of this verification, it becomes possible for the certificate verifying unit 1093 to verify that the entrustor template certificate has actually been issued by the certificate authority.

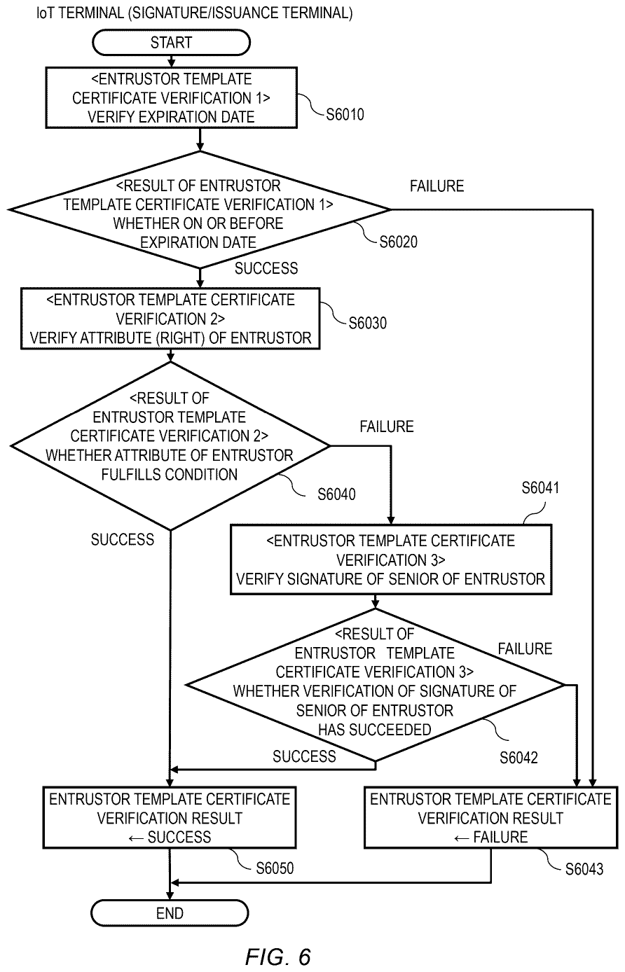

The certificate verifying unit 1093 performs a conditional branch (S4080) on the basis of result of the verifications in step S4070. If all the verifications conducted in step S4070 have succeeded, the certificate verifying unit 1093 substitutes success into the implementation condition verification result (S4090) and proceeds to processing from step S4100 onwards. If these verifications have failed, the certificate verifying unit 1093 substitutes failure into the implementation condition verification result (S4091). Details of the processing in step S4070 and those of the processing in step S4080 will be described later using FIG. 6.

If success is substituted into the implementation condition verification result in step S4090, the certificate verifying unit 1093 transfers a processing right to a target device/app 1300 and causes the target device/app 1300 to perform processing (S4100). As a more specific example, in step S4100, the certificate verifying unit 1093 acquires a target device/app serial number and an entrustment content from the device certificate acquired in step S4020, and the communication unit 1010 instructs the device/app 1300 indicated by the acquired target device/app serial number to perform processing having an implementation content indicated by the acquired entrustment content.

The hash value generating unit 1092 generates a hash value (S4110) responsive to the implementation information acquired in step S4010.

The signature generating unit 1070 acquires a device secret key from the key storing unit 1090 that corresponds to the device certificate acquired in step S4020, and adds a signature (S4120) using the acquired device secret key to the hash value generated in step S4110. Adding the signature to the implementation information using the device secret key makes it possible to prevent tampering of the implementation information.

The certificate verifying unit 1093 records a log of the entrustor template certificate verification processing, a log of the device certificate verification processing, and a log of the processing (processing indicated by the implementation content included in the entrustment content) of the device/app 1300 having received the transferred processing right has performed in step S4100 on the basis of the transferred processing right (this log is received from this device/app 1300), and holds the logs in the IoT terminal 1000 (S4130). On the basis of these logs and the device certificate, the entrustor, the senior, an interested party, or the like can confirm that the processing by the device/app 1300 has been performed on the basis of the processing right transferred from the valid entrustor and that the processing performed by the device/app 1300 having received the transferred processing right is processing intended by the entrustor.

The communication unit 1010 transmits the entrustor template certificate acquired in step S4070, the device certificate acquired in step S4020, and the implementation information given the signature in step S4120 to the verification terminal 1100 (S4140). The verification terminal 1100 may acquire the entrustor template certificate from the entrustor template repository 1200 (as an example, the communication unit 1010 notifies the verification terminal 1100 of an entrustor template certificate serial number of the entrustor template certificate acquired in step S4070, and the verification terminal 1100 requests the entrustor template repository 1200 to transmit the entrustor template certificate corresponding to the notified entrustor template certificate serial number).

One of the device certificate verification processing in step S4040 and step S4050 and the entrustor template certificate verification processing in step S4070 and step S4080 is omissible.

In this way, the right transfer processing by the IoT terminal 1000 is completed.

FIG. 5 is a flowchart showing exemplary details of the device certificate verification processing in step S4040 and step S4050.

The certificate verifying unit 1093 verifies whether the expiration date 7060 of the device certificate is after the current time (S5010). The certificate verifying unit 1093 performs a conditional branch (S5020) on the basis of result of the verification in step S5010. If the verification in step S5010 has succeeded, the certificate verifying unit 1093 proceeds to processing from step S5021 onwards. If the verification in step S5010 has failed, the certificate verifying unit 1093 substitutes failure into device certificate verification result (S5030). If failure is substituted into the device certificate verification result, device certificate verification result in step S4050 is determined to be failure.

The certificate verifying unit 1093 verifies whether the implementation condition is fulfilled (S5021). As a more specific example, in accordance with information included in the reply received from each device/app 1300 in step S4030 (specifically, information for determining whether the implementation condition is fulfilled), the certificate verifying unit 1093 determines the presence or absence of the device/app 1300 having transmitted a reply indicating fulfillment of the implementation condition. If the certificate verifying unit 1093 determines that the device/app 1300 having transmitted the reply indicating fulfillment of the implementation condition is present, the certificate verifying unit 1093 determines that the verification in step S5021 has succeeded. If the certificate verifying unit 1093 determines that the device/app 1300 having transmitted the reply indicating fulfillment of the implementation condition is absent, the certificate verifying unit 1093 determines that the verification in step S5021 has failed.

The certificate verifying unit 1093 performs a conditional branch (S5022) on the basis of result of the verification in step S5021. If the verification in step S5021 has succeeded, the certificate verifying unit 1093 performs processing from step S5023 onwards. If the verification in step S5021 has failed, the certificate verifying unit 1093 substitutes failure into the device certificate verification result (S5030).

The certificate verifying unit 1093 verifies a serial number of the target device/app 1300 (S5023). As a more specific example, the certificate verifying unit 1093 determines the presence or absence of the device/app 1300 having transmitted the reply indicating fulfillment of the implementation condition (as described above, this reply includes a device/app serial number) and having a device/app serial number conforming to the target device/app serial number 7081 of the device certificate. If the certificate verifying unit 1093 determines that the device/app 1300 having transmitted the reply indicating fulfillment of the implementation condition and having a device/app serial number conforming to the target device/app serial number 7081 of the device certificate is present, the certificate verifying unit 1093 determines that the verification in step S5023 has succeeded. If the certificate verifying unit 1093 determines that the device/app 1300 having a device/app serial number conforming to the target device/app serial number 7081 of the device certificate is absent, the certificate verifying unit 1093 determines that the verification in step S5023 has failed.

As an example, if the certificate verifying unit 1093 determines the presence of a plurality of the devices/apps 1300 having transmitted the replies indicating fulfillment of the implementation condition and having device/app serial numbers conforming to the target device/app serial number 7081 of the device certificate, the certificate verifying unit 1093 may determine the device/app 1300 belonging to these devices/apps 1300 and having transmitted the reply first to be the target device/app 1300 (a candidate therefor) to which the processing right is to be transferred.

The certificate verifying unit 1093 performs a conditional branch (S5024) on the basis of result of the verification in step S5023. If the verification in step S5023 has succeeded, the certificate verifying unit 1093 substitutes success into the device certificate verification result (S5025). If the verification in step S5023 has failed, the certificate verifying unit 1093 substitutes failure into the device certificate verification result (S5030). If success is substituted into the device certificate verification result, the device certificate verification result in step S4050 is determined to be success.

In the above-described example, the processing right is transferred to the target device/app 1300 after the certificate verifying unit 1093 verifies whether the implementation condition is fulfilled in the processing in step S5021 included in the device certificate verification processing in step S4040. However, the target device/app 1300 may be responsible for determining whether the implementation condition is fulfilled.

As a more specific example, the processing for acquiring the implementation information is omitted in step S4030, and the processing in step S5021 and the processing in step S5022 are omitted from the device certificate verification processing in step S4040 (in this case, if a determination “success” is made as a result of the processing in step S5020, the flow proceeds to the processing in step S5023). By doing so, the determination relating to the implementation condition by the certificate verifying unit 1093 is omitted. Furthermore, in step S4100, the certificate verifying unit 1093 may acquire a target device/app serial number and an entrustment content from the device certificate acquired in step S4020. If an implementation condition indicated by the acquired entrustment content is determined to be fulfilled, the communication unit 1010 may instruct the device/app 1300 indicated by the acquired target device/app serial number to perform processing indicated by the implementation content. Specifically, the target device/app 1300 acquires implementation information, for example, on a regular basis, determines by itself whether the implementation condition is fulfilled, and performs processing having a corresponding implementation content if the implementation condition is determined to be fulfilled.

Any one or two verifications of the three verifications shown in FIG. 5 (the verification about the expiration date, the verification about the implementation condition, and the verification about the target device/app serial number) are omissible.

In this way, the device certificate verification processing by the certificate verifying unit 1093 is completed.

FIG. 6 is a flowchart showing exemplary details of the entrustor template certificate verification processing in step S4070 and step S4080.

The certificate verifying unit 1093 verifies whether the expiration date 7160 of the entrustor template certificate is after the current time (S6010).

The certificate verifying unit 1093 performs a conditional branch (S6020) on the basis of result of the verification in step S6010. If this verification has succeeded, the certificate verifying unit 1093 proceeds to processing from step S6030 onwards. If this verification has failed, the certificate verifying unit 1093 substitutes failure into entrustor template certificate verification result (S6043). If failure is substituted into the entrustor template certificate verification result, entrustor template certificate verification result in step S4080 is determined to be failure.

The certificate verifying unit 1093 verifies the entrustor attribute 7180 of the entrustor template certificate (S6030). The entrustor attribute 7180 includes at least one of a rating of the entrustor, work achievement (experience) of the entrustor, a qualification of the entrustor, and others (each of these pieces of information shows the performance of the entrustor).

The entrustor condition stored in advance in the entrustor condition storing unit 1094 defines an attribute of an entrustor allowed to transfer a processing right to the device/app 1300. If an attribute indicated by the entrustor attribute 7180 is included in the attribute defined by the entrustor condition, the verification in step S6030 is determined to have succeeded.

As described above, the attribute of the entrustor allowed to transfer the processing right indicated by the entrustor condition may be defined for each device/app 1300, for each implementation content, or for each combination of the device/app 1300 and the implementation content. In this case, the certificate verifying unit 1093 identifies the target device/app serial number 7081 or an implementation content indicated by the entrustment content 7080 of the device certificate, and verifies whether an entrustor condition corresponding to the identified device/app 1300 or the identified implementation content is fulfilled.

As described above, a list of identifiers of entrustors allowed to transfer the processing right to the device/app 1300 may be described as the entrustor condition. In this case, if an entrustor 7070 indicated by the entrustor template is included in this list, the certificate verifying unit 1093 determines that the verification in step S6030 has succeeded.

The certificate verifying unit 1093 performs a conditional branch (S6040) on the basis of result of the verification in step S6030. If this verification has succeeded, the certificate verifying unit 1093 substitutes success into the entrustor template certificate verification result (S6050). If this verification has failed, the certificate verifying unit 1093 proceeds to processing from step S6041 onwards. If success is substituted into the entrustor template certificate verification result, the entrustor template certificate verification result in step S4080 is determined to be success.

The certificate verifying unit 1093 verifies the entrustor's senior signature 7190 of the entrustor template certificate (S6041).

If the certificate verifying unit 1093 determines that the entrustor's senior signature 7190 of the entrustor template certificate includes a signature value, the certificate verifying unit 1093 determines that the verification in step S6041 has succeeded.

A list of identifiers of seniors may be described as the entrustor condition, for example. If an ID of the senior indicated by the entrustor's senior signature 7190 of the entrustor template certificate is included in this list, the certificate verifying unit 1093 may determine that the verification in step S6041 has succeeded.

The certificate verifying unit 1093 may verify the signature of the senior in accordance with an algorithm (described in the entrustor's senior signature 7190 of the entrustor template certificate, for example) by which this signature has been generated, and may determine that the verification in step S6041 has succeeded only if the verification of this signature has succeeded.

The certificate verifying unit 1093 performs a conditional branch (S6042) on the basis of result of the verification in step S6041. If the verification in step S6041 has succeeded, the certificate verifying unit 1093 substitutes success into the entrustor template certificate verification result (S6050). If the verification in step S6041 has failed, the certificate verifying unit 1093 substitutes failure into the entrustor template certificate verification result (S6043).

Any one or two verifications of the three verifications shown in FIG. 6 (the verification about the expiration date, the verification about the entrustor's attribute, and the verification about the signature of the entrustor's senior) are omissible.

In this way, the entrustor template certificate verification processing by the certificate verifying unit 1093 is completed.

FIGS. 7A and 7B are views showing the data configuration of the device certificate and that of the entrustor template certificate respectively.

FIG. 7A shows an example of the data configuration of a device certificate 7000.

The device certificate 7000 is data generated by adding a biometric signature using biometric information as a key to the device public key generated in step S3040, and is compliant with X.509 as a standard of a public key certificate (corresponding to the device certificate in the present embodiment) according to a PKI (Public Key Infrastructure). The device certificate 7000 will be described below by referring to the drawing.

A version 7010 indicates a character string showing a version of the device certificate.

An entrustor template serial number 7020 is a serial number uniquely allocated to the entrustor template by the entrustor template repository 1200 corresponding to the device certificate 7000 concerned, and is added in a manner avoiding duplication thereof.

A device public key serial number 7030 is a unique character string added to the device public key by the device key pair generating unit 1040 of the IoT terminal 1000, and is generated in a manner avoiding duplication between different device public keys.

A biometric signature algorithm 7040 indicates an algorithm for generating a biometric signature value 7093.

An issuer 7050 indicates a subject that issues the entrustor template certificate, namely, the certificate authority.

The expiration date 7060 indicates a date and time of an expiration date of the device certificate.

The entrustor 7070 indicates an entrustor (a subject of the device certificate, namely, a user who requests issuance).

The entrustment content 7080 indicates an implementation condition for processing whose right is to be transferred to the device/app 1300, an implementation content of the processing, and others.

The target device/app serial number 7081 indicates a serial number (identifier) of the device/app 1300 to which the right is to be transferred. While a serial number of one device/app 1300 is stored in principle in the target device/app serial number 7081, serial numbers of a plurality of the devices/apps 1300 may be storable therein. If the serial numbers of the plurality of devices/apps 1300 are stored in the target device/app serial number 7081, the processing right based on the device certificate concerned is transferred to all of these devices/apps 1300 in transferring this processing right.

A device public key algorithm 7091 indicates an algorithm for generating a device public key 7092.

The device public key 7092 indicates the device public key generated in step S3040.

The biometric signature value 7093 is a value obtained by inputting data from the version 7010 to the device public key 7092 into a predetermined hash function (for example, SHA1, SHA256, etc.) and generating a biometric signature using biometric information as a key for a resultant hash value.

The data configuration of the device certificate 7000 is as has been described above.

FIG. 7B shows an example of the data configuration of an entrustor template certificate 7100. The entrustor template certificate 7100 is data generated in step S2130 in FIG. 2. A basic data configuration thereof is determined by adding other types of header information such as information about the entrustor, information about a senior of the entrustor, etc., and adding a signature value 7193 to an entrustor template 7192, and is compliant with X. 509 as a standard for a public key certificate (corresponding to the device certificate in the present embodiment) according to a PKI (Public Key Infrastructure). Each piece of data will be described below.

A version 7110 indicates a version of the entrustor template certificate using a character string.

An entrustor template serial number 7120 is a character string uniquely allocated to the entrustor template by the entrustor template repository 1200, and is added in a manner avoiding duplication thereof.

A signature algorithm 7140 indicates an algorithm for generating the signature value 7193 to be added to the entrustor template certificate.

An issuer 7150 indicates a subject that issues the entrustor template certificate, namely, the certificate authority.

The expiration date 7160 indicates a date and time of an expiration date of the entrustor template certificate.

An entrustor 7170 indicates an entrustor (a subject of the entrustor template certificate, namely, a user who requests issuance) that entrusts transfer of a processing right to the target device/app 1300.

The entrustor attribute 7180 indicates an attribute of the entrustor (a rating, achievement, experience or the like of the entrustor as described above, for example).

The entrustor's senior signature 7190 indicates a signature by a senior of the entrustor.

A biometric signature algorithm 7191 indicates an algorithm for generating the entrustor template certificate 7100.

The entrustor template 7192 indicates the entrustor template generated in step S3030 in FIG. 3.

The signature value 7193 is a value obtained by inputting data from the version 7110 to the entrustor template 7192 into a predetermined hash function (for example, SHA1, SHA256, etc.) and converting a resultant hash value using the secret key of the certificate authority.

The data configuration of the entrustor template certificate 7100 is as has been described above.

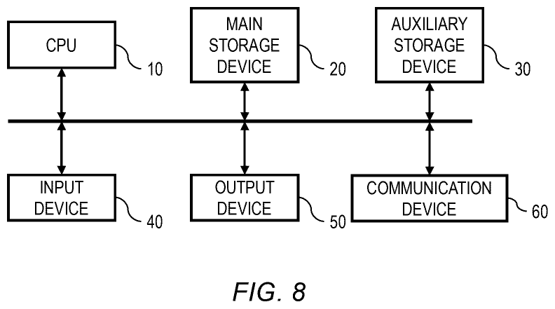

FIG. 8 is a block diagram showing an exemplary hardware configuration of the IoT terminal 1000, the verification terminal 1100, the entrustor template repository 1200, and the IoT terminal 1400 in the processing right transfer system.

The IoT terminal 1000, the verification terminal 1100, the entrustor template repository 1200, and the IoT terminal 1400 are each composed of a computer including a CPU (Central Processing Unit) 10, a main storage device 20, an auxiliary storage device 30, an input device 40, an output device 50, and a communication device 60, for example.

The CPU 10 executes a program corresponding to each of the biometric information acquiring unit 1020, the entrustor template generating unit 1030, the device key pair generating unit 1040, the device certificate generating unit 1050, the implementation information acquiring unit 1060, the signature generating unit 1070, the entrustment information acquiring unit 1080, the hash value generating unit 1092, the certificate verifying unit 1093, the certificate verifying unit 1120, the signature verifying unit 1130, and the entrustor template certificate generating unit 1220.

The main storage device 20 is a device corresponding to a memory of the computer, and stores the program corresponding to each of the biometric information acquiring unit 1020, the entrustor template generating unit 1030, the device key pair generating unit 1040, the device certificate generating unit 1050, the implementation information acquiring unit 1060, the signature generating unit 1070, the entrustment information acquiring unit 1080, the hash value generating unit 1092, the certificate verifying unit 1093, the certificate verifying unit 1120, the signature verifying unit 1130, and the entrustor template certificate generating unit 1220. By causing the CPU 10 to execute each of these programs, a corresponding type of the processing is realized.

The auxiliary storage device 30 is a storage device represented by an HDD (Hard Disk Drive) or an SSD (Solid State Drive), for example, and corresponds to the key storing unit 1090, the entrustor template certificate storing unit 1091, the entrustor condition storing unit 1094, the entrustor template certificate storing unit 1230, and the entrustment information storing unit 1240. Data stored in each of these units is accumulated as data in the auxiliary storage device 30.

The input device 40 includes a mouse, a keyboard, and the like for accepting input from an operator, and a sensor for acquiring biometric information. The output device 50 includes a display, a printer or the like, and outputs result of execution of a program and information in the main storage device 20. The communication device 60 is used in communicating with a different device, and realizes communications by the communication unit 1010, the communication unit 1110, and the communication unit 1210.

The CPU 10 performs processing in accordance with a program corresponding to each functional unit loaded on the main storage device 20, thereby operating as a functional unit to provide a predetermined function. As an example, the CPU 10 performs processing in accordance with an entrustor template generation program loaded on the main storage device 20, thereby functioning as the entrustor template generating unit 1030. This also applies to the other programs. The CPU 10 further operates as a functional unit to provide a function of each of plural pieces of processing to be performed by the corresponding programs. The computer and a computer system are a device and a system including these functional units.

The programs and information such as tables for implementing corresponding functions can be stored in a storage device such as the auxiliary storage device 30, a nonvolatile semiconductor memory, a hard disk drive or an SSD (Solid State Drive), or a computer-readable non-transitory data storage medium such as an IC card, an SD card or a DVD.

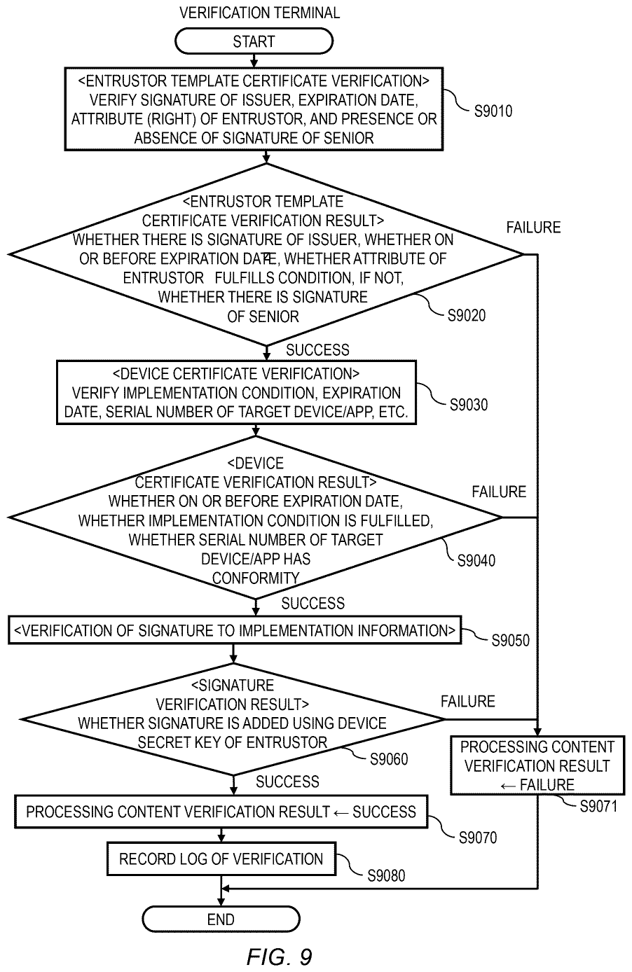

FIG. 9 is a flowchart showing an example of verification processing by the verification terminal 1100. In this processing, the verification terminal 1100 verifies the entrustor template certificate transmitted in step S2140, the device certificate, and the signature added to the implementation information.

The certificate verifying unit 1120 and the signature verifying unit 1130 of the verification terminal 1100 perform entrustor template certificate verification processing (S9010). More specifically, in addition to implementation of verification similar to that in step S4070 by the certificate verifying unit 1120 (the verification terminal 1100 acquires an entrustor condition from the IoT terminal 1000), the signature verifying unit 1130 verifies the presence or absence of a signature of an issuer of the entrustor template certificate (specifically, verifies whether a signature is stored in the signature value 7193). As the signature value 7193 is generated using the secret key of the certificate authority, the signature verifying unit 1130 may verify the signature value 7193 using the public key of the certificate authority, for example.

The certificate verifying unit 1120 performs a conditional branch (S9020) on the basis of result of the verifications in step S9010. If all the verifications conducted in step S9010 have succeeded, the certificate verifying unit 1120 proceeds to processing from step S9030 onwards. If these verifications have failed, the certificate verifying unit 1120 substitutes failure into processing content verification result (S9071).

The certificate verifying unit 1120 conducts device certificate verification processing (S9030). As a more specific example, the certificate verifying unit 1120 conducts verification similar to that in step S4040. The verification in step S5021 included in the processing in step S4040 requires information indicating whether an implementation condition is fulfilled. The verification in step S5023 included in the processing in step S4040 requires information indicating a device/app serial number of the device/app 1300 having made a reply fulfilling this implementation condition. As an example, the communication unit 1010 incorporates these pieces of information into implementation information (given a signature) and transmits resultant information to the verification terminal 1100 in the processing in step S4140, thereby disclosing these pieces of information to the verification terminal 1100. These pieces of information may not have to be disclosed to the verification terminal 1100. In this case, verification processing similar to that in step S5021 and verification processing similar to that in step S5023 are omissible in step S9030.

The certificate verifying unit 1120 performs a conditional branch (S9040) on the basis of result of the verifications in step S9030. If all the verifications conducted in step S9030 have succeeded, the certificate verifying unit 1120 proceeds to processing from step S9050 onwards. If these verifications have failed, the certificate verifying unit 1120 substitutes failure into the processing content verification result (S9071).

The signature verifying unit 1130 verifies the signature added to the implementation information (S9050). As a more specific example, by using the device public key 7092 included in the device certificate, the signature verifying unit 1130 verifies whether the signature added to the implementation information has been generated using the device secret key.

The certificate verifying unit 1120 performs a conditional branch (S9060) on the basis of result of the verification in step S9050. If the verification conducted in step S9050 has succeeded, the certificate verifying unit 1120 substitutes success into the processing content verification result (S9070). If this verification has failed, the certificate verifying unit 1120 substitutes failure into the processing content verification result (S9071).

If success is substituted into the processing content verification result, the certificate verifying unit 1120 records a log of the entrustor template certificate verification, a log of the device certificate verification, and a log of the verification of the signature added to the implementation information conducted by the verification terminal 1100, and holds these logs in the verification terminal 1100 (S9080). The certificate verifying unit 1120 may perform the processing for recording the logs in step S9080 if failure is substituted into the processing content verification result.

In this way, the verification processing by the verification terminal 1100 is completed.

As a result of the verification processing in FIG. 9, it is possible for the verification terminal 1100 to verify that the proper device/app 1300 has performed processing in accordance with the implementation content described in the device certificate on or before the expiration date, which is processing in line with the implementation content based on the implementation information fulfilling the implementation condition and having been verified to be free from tampering. It is further possible for the verification terminal 1100 to verify that the entrustor template on or before the expiration date has been generated under a valid right (specifically, generated by an entrustor having a valid right or approved by a senior having a valid right).

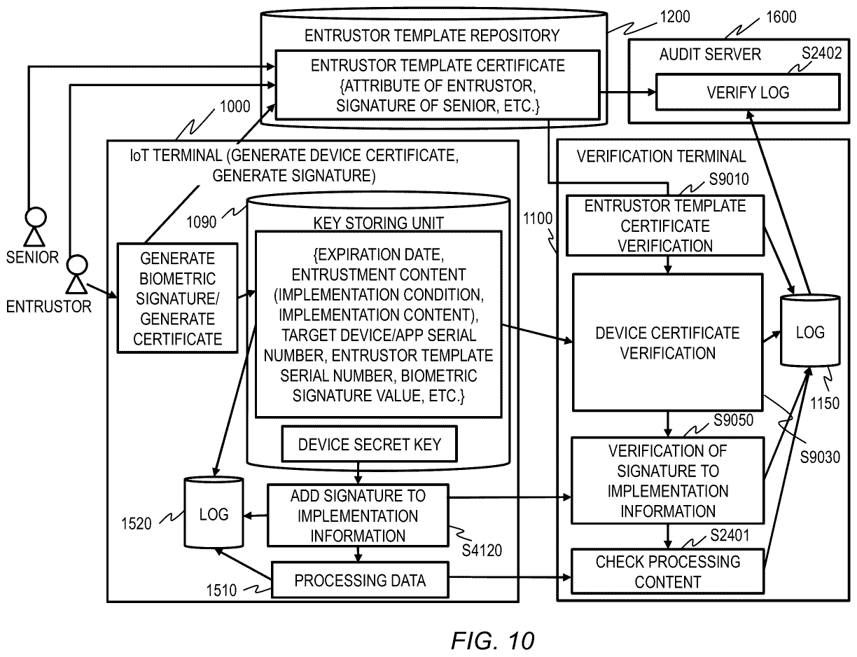

FIG. 10 is an explanatory view showing an exemplary outline of entire processing by the processing right transfer system. As shown in FIG. 10, the processing right transfer system may further include an audit server 1600. In the example shown in FIG. 10, illustrations of some of the structures belonging to the processing right transfer system shown in FIG. 1 are omitted.

The IoT terminal 1000 generates a device key pair, and an entrustor template and a device certificate based on a biometric signature in accordance with the processing shown in FIG. 3. The IoT terminal 1000 transmits the entrustor template to the entrustor template repository 1200. The entrustor template repository 1200 generates an entrustor template certificate including an entrustor attribute (and if necessary, an entrustor's senior signature), and holds the entrustor template certificate in the entrustor template repository 1200 itself and transmits the same to the IoT terminal 1000 in accordance with the method shown in FIG. 2. The IoT terminal 1000 stores the generated device certificate and a device secret key included in the device key pair into the key storing unit 1090 of the IoT terminal 1000 itself.

The IoT terminal 1000 adds a signature to implementation information using the device secret key in step S4120. The IoT terminal 1000 performs the device certificate verification processing in step S4040 and the entrustor template certificate verification processing in step S4070. If these verifications have succeeded, the IoT terminal 1000 transfers a processing right to the target device/app 1300 in step S4100.

The device/app 1300 having received the transferred processing right performs processing indicated by an implementation content. The IoT terminal 1000 stores processing data 1510 into a log 1520 (S4130). The processing data 1510 includes data generated by the implementation of the processing (this data is transmitted from the device/app 1300 concerned to the IoT terminal 1000), the implementation information given the signature in step S4120, and others. The IoT terminal 1000 may further store a log of processing for generating each certificate or a log of the right transfer processing in FIGS. 4A and 4B into the log 1520.

The IoT terminal 1000 may transmit the processing data 1510 to the verification terminal 1100 and the verification terminal 1100 may check a processing content (S2401). The verification terminal 1100 acquires the entrustor template certificate from the IoT terminal 1000 or the entrustor template repository 1200, and acquires the device certificate from the IoT terminal 1000.

The verification terminal 1100 performs the entrustor template certificate verification processing in step S9010, the device certificate verification processing in step S9030, and the signature verification processing given to implementation information in S9050, and stores results of these pieces of verification processing and result of the processing content checking processing in step S2401 into a log 1150.

The verification terminal 1100 transmits the log 1150 to the audit server 1600. The audit server 1600 verifies the received log. As a more specific example, on the basis of the log 1150, the audit server 1600 conducts verification to see when the entrustor template certificate and the device certificate were used and to see processing for which these certificates were used (or to see when the entrustor template certificate and the device certificate were used and to see a processing right to be transferred for which these certificates were used), verifies which verification terminal 1100 performed the verification processing, or verifies result of the verification by the verification terminal 1100. By causing the audit server 1600 to verify the log 1150, it becomes possible for a user of the audit server 1600 (who may be a third party, for example) to see whether a transfer cycle of a processing right is functioning normally.

As described above, according to the first embodiment, it is possible to generate an entrustor template certificate from biometric information about a user, to generate a pair of a device secret key and a device public key, to generate a device certificate by adding a biometric signature to the device public key using the biometric information about the user as a key, to verify the validity of the device certificate using the entrustor template certificate, and to further verify the validity of the signature of the user using the device certificate.

It is further possible to add a signature to the entrustor template certificate using a secret key of the certificate authority and to verify validity using a public key of the certificate authority corresponding to the secret key of the certificate authority at the time of signature verification.

The entrustor template certificate is given an attribute of an entrustor and if necessary, given a signature of a senior of the entrustor. In the entrustor template certificate verification processing, verification is conducted to see whether the attribute of the entrustor fulfills an entrustor condition or whether the signature by the senior of the entrustor is given even if the attribute of the entrustor does not fulfill the entrustor condition. By doing so, a processing right is transferred to the device/app 1300 by a person having a valid right.

The device certificate is given a serial number of the device/app 1300, an implementation condition, an implementation content of processing whose right is to be transferred, and others. In the device certificate verification processing, verification is conducted to see that the proper device/app is to perform the processing and whether the implementation condition is fulfilled. This provides a guarantee that the proper device/app 1300 will perform the processing and prevents the occurrence of a situation where this device/app 1300 will perform processing not intended by the entrustor.

The processing right transfer system may not have to include the entrustor template repository 1200. In this case, the processing performed by the entrustor template repository 1200 described in the present embodiment is performed by the IoT terminal 1000, and the information held by the entrustor template repository 1200 described in the present embodiment is held by the IoT terminal 1000, for example. Moreover, in this case, the communication between the IoT terminal 1000 and the entrustor template repository 1200 described in the present embodiment is omitted.

### Second Embodiment

In the present embodiment, an exemplary entrustment right of an entrustor in the processing right transfer system of the first embodiment will be described. In the following, unless otherwise specified, the configuration of a processing right transfer system and processing performed by the processing right transfer system of the present embodiment are the same as those of the first embodiment.

As described in the first embodiment, an entrustor template certificate and a device certificate corresponding to one entrustor have been generated, and a right to processing having an implementation condition and an implementation content indicated by the device certificate has been transferred to the device/app 1300 indicated by the device certificate by causing the IoT terminal 1000 to verify the entrustor template certificate and the device certificate.

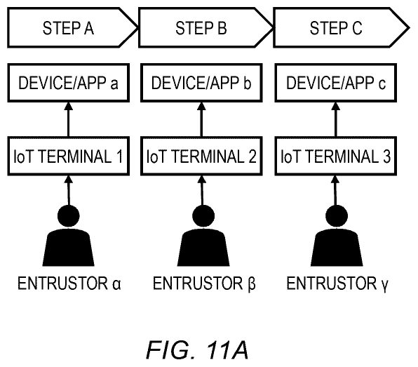

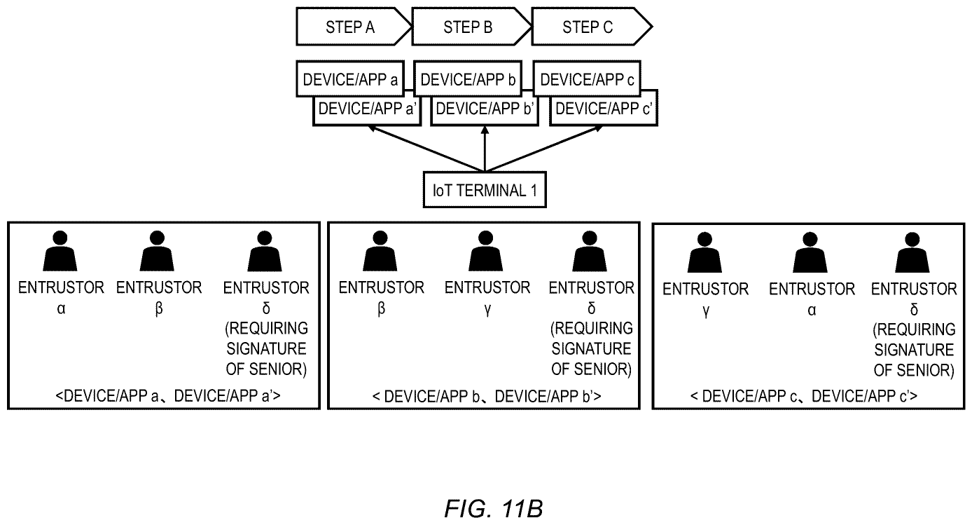

FIG. 11A is an explanatory view showing an exemplary entrustment right of an entrustor. The example in FIG. 11A is shown under the presence of three entrustors (called an entrustor α, an entrustor β, and an entrustor γ individually), three IoT terminals 1000 (called an IoT terminal 1, an IoT terminal 2, and an IoT terminal 3 individually), three devices/apps 1300 (called a device/app a, a device/app b, and a device/app c individually), and three steps (a step A to be performed by the device/app a, a step B to be performed by the device/app b, and a step C to be performed by the device/app c).

The device/app a is given a processing right to perform the step A by the entrustor α. The device/app b is given a processing right to perform the step B by the entrustor β. The device/app c is given a processing right to perform the step C by the entrustor γ. Specifically, as an example, the IoT terminal 1 generates an entrustor template for the entrustor a and a device certificate to be used by the entrustor a for transferring a processing right indicating the step A as an implementation content to the device/app a, verifies an entrustor template certificate corresponding to the generated entrustor template and verifies the device certificate, and causes the processing right to be transferred to the device/app a. This also applies to transfer of a processing right relating to the step B and transfer of a processing right relating to the step C.

The step B becomes implementable only after implementation of the step A, and the step C becomes implementable only after implementation of the step B. Thus, if an implementation condition in the device certificate corresponding to the entrustor β specifies completion of implementation of the step A and an implementation condition in the device certificate corresponding to the entrustor γ specifies completion of implementation of the step B, processing proceeds in the order of the step A, the step B, and the step C.

As shown in FIG. 11A, (a series of) different pieces of processing such as the step A, the step B, and the step C may be performed by the respective different devices/apps 1300, and entrustor template generating processing, device certificate generating processing, and processing for verifying each type of certificate for transferring a processing right to processing by each of these devices/apps 1300 may be performed by a corresponding one of the different IoT terminals 1000.

FIG. 11B is an explanatory view showing an exemplary entrustment right of an entrustor. The example shown in FIG. 11B differs from the example shown in FIG. 11A in that one IoT terminal 1000 (called an IoT terminal 1) is provided, six devices/apps 1300 are provided (a device/app a′, a device/app b′, and a device/app c′ are added), and the step A, the step B, and the step C are further implementable by the device/app a′, by the device/app b′, and by the device/app c′ respectively.

The example shown in FIG. 11B further differs from the example shown in FIG. 11A in that each of the device/app a and the device/app a′ is given a processing right to perform the step A by an entrustor α, an entrustor β, or an entrustor δ (here, the entrustor δ requires a signature of a senior), each of the device/app b and the device/app b′ is given a processing right to perform the step B by the entrustor β, an entrustor γ, or the entrustor δ (here, the entrustor δ requires a signature of a senior), and each of the device/app c and the device/app c′ is given a processing right to perform the step C by the entrustor γ, the entrustor α, or the entrustor δ (here, the entrustor δ requires a signature of a senior).

Each of a plurality of steps (implementation contents) may be performed by one device/app 1300 or may be performed by any of a plurality of the different devices/apps 1300 like in the example shown in FIG. 11B. Furthermore, each of the plurality of devices/apps 1300 may receive a processing right transferred from any one entrustor or may receive a processing right transferred from any one of a plurality of entrustors like in the example shown in FIG. 11B. While not shown in FIG. 11B, even with the same entrustment content, with the same device/app serial number, or with the same entrustor, it is possible to set a plurality of expiration dates for a device certificate.

Thus, a maximum number of device certificates prepared for transfer of a processing right is calculated as: the number of target devices/apps x the number of entrustors x the number of entrustment contents x the number of expiration dates.

As shown in the second embodiment, in the presence of a plurality of sequential steps or in a case where processing in one step can be performed by a plurality of devices/apps 1300, even if an entrustor differs between the devices/apps 1300, causing the IoT terminal 1000 to transfer a processing right in advance still makes it possible to perform autonomous processing based on an intention by an entrustor.

### Third Embodiment In a third embodiment, use cases of the processing right transfer system of the first embodiment will be described.

### Use Case 1: Setting of Device of Manufacturing Line in Factory or Processing Implementation Instruction

In a use case 1, the processing right transfer system functions as a production management system for a manufacturing line in a factory, and the device/app 1300 is a device belonging to the manufacturing line in the factory. A worker at the manufacturing line in the factory is an entrustor, and a superintendent of the manufacturing line in the factory is a senior of the entrustor. Specifically, an entrustor template and a signature to be added to a device certificate are generated using biometric information about the worker. The entrustor template may include a signature of the superintendent.

An implementation condition in the use case 1 includes a condition that an operation schedule of the device concerned has a spare time, a condition that excessive inventory of products manufactured by the device concerned falls below a specified quantity, a condition that a material for objects to be manufactured by the device concerned is secured, a condition that order for a product to be manufactured by the device concerned is accepted, and a condition that a repository for a product to be manufactured by the device concerned is provided, and others, for example. An entrustor condition in the use case 1 includes a condition that the entrustor is a worker having a right to handle the device concerned, and others, for example.

If the verifications in step S4040 and step S4080 have succeeded (here, verification of the implementation condition in step S5021 included in step S4040 may be conducted by the device concerned after a processing right is transferred to the device concerned), the processing right is transferred to the device concerned, and autonomous setting change of the device concerned is made and start, stop, etc. of processing by the device concerned are realized as an implementation content indicated by implementation information, and a signature is added to the implementation information using a device secret key. By doing so, the processing is performed without the need for the entrustor to present a living body on each occasion of processing.

Correspondence between the significance of the implementation content and a qualification and achievement check of the worker is described in the entrustor condition. In step S6030, verification is conducted to see whether a qualification and achievement of the worker indicated by the entrustor attribute 7180 of an entrustor template certificate fulfill a qualification and achievement corresponding to an implementation content indicated by the entrustment content 7080 of the device certificate (under the entrustor condition). If these qualification and achievement are determined not to be fulfilled, the verification in step S6041 is conducted.

The IoT terminal 1000 checks the expiration date 7160 of the entrustor template certificate stored in the entrustor template certificate storing unit 1091 and checks the expiration date 7060 of the device certificate stored in the key storing unit 1090, for example, on a regular basis. If time periods until these expiration dates become equal to or less than predetermined time periods, the IoT terminal 1000 may make indication urging update of these certificates on the output device 50 of the IoT terminal 1000. This also applies to use cases described later.

A purchaser of a product manufactured by the device concerned can see from the entrustor template certificate, the device certificate, and the implementation information (with a signature) that the product is an object manufactured as a result of implementation of processing entrusted to the device concerned based on the intention by the worker (and the superintendent).

### Use Case 2: Power Transaction Using Autonomous Trading System

In a use case 2, the processing right transfer system functions as a power trading system, and the device/app 1300 is a power transaction terminal belonging to an intermediary of power transaction. Each of a power consumer (buyer) and a power supplier (seller) is an entrustor. Specifically, an entrustor template and a signature to be added to a device certificate are generated using biometric information about each of the power consumer (buyer) and the power supplier (seller). The entrustor template may include a signature of a senior of each of the power consumer (buyer) and the power supplier (seller).

An implementation condition on the side of the power consumer (buyer) in the use case 2 includes a condition that an expected power shortfall is equal to or greater than a predetermined value, a condition that a source for power to be consumed is of a predetermined type, a condition that a power transaction price is equal to or less than a predetermined value, a condition that a length of time when power shortage is expected to occur is equal to or greater than a predetermined value, and others, for example.

An implementation condition on the side of the power supplier (seller) in the use case 2 includes a condition that an expected power surplus amount is equal to or greater than a predetermined value, a condition that a source for power to be supplied is of a predetermined type, a condition that a power transaction price is equal to or greater than a predetermined value, a condition that a length of time when power surplus is expected to occur is equal to or greater than a predetermined value, and others, for example. The power trading system may include a smart meter installed on the power consumer (buyer) or the power supplier (seller) or a power generating facility installed on the power supplier (seller), for example.

If the verifications in step S4040 and step S4080 have succeeded (here, verification of the implementation condition in step S5021 included in step S4040 may be conducted by the power transaction terminal after a processing right is transferred to the power transaction terminal), the processing right is transferred to the power transaction terminal, power buying and selling is conducted autonomously between the power consumer (buyer) and the power supplier (seller) as an implementation content indicated by implementation information, and a signature is added to the implementation information using a device secret key. By doing so, the processing is performed without the need for the entrustor to present a living body on each occasion of processing.

The power consumer (buyer) and the power supplier (seller) can see from an entrustor template certificate, the device certificate, and the implementation information (with a signature) that the power transaction processing via the power transaction terminal has been performed on the basis of the intentions by the power consumer (buyer) and the power supplier (seller).

### Use Case 3: Autonomous Issuance of Inspection Passing Certificate

In a use case 3, the processing right transfer system functions as an inspection system that inspects a product in a manufacturing line in a factory, and the device/app 1300 is an issuance device that issues an inspection passing certificate for the product manufactured by the manufacturing line. An inspection worker at the manufacturing line in the factory is an entrustor, and an inspection superintendent of the manufacturing line in the factory is a senior of the entrustor. Specifically, an entrustor template and a signature to be added to a device certificate are generated using biometric information about the inspection worker. The entrustor template may include a signature of the inspection superintendent.

An implementation condition in the use case 3 includes a condition that a part obtained from a predetermined procurement source is used in a product to be inspected, a condition that the product to be inspected has been manufactured in response to an instruction (or on receipt of entrustment) from a worker having a right to use the issuance device, a condition that inspection in line with a predetermined process is conducted on the product to be inspected, a condition that the product to be inspected fulfills a predetermined performance requirement, and others, for example.

If the verifications in step S4040 and step S4080 have succeeded (here, verification of the implementation condition in step S5021 included in step S4040 may be conducted by the issuance device after a processing right is transferred to the issuance device), the processing right is transferred to the issuance device, an inspection passing certificate is issued autonomously as an implementation content indicated by implementation information, and a signature is added to the implementation information using a device secret key. By doing so, the processing is performed without the need for the entrustor to present a living body on each occasion of processing.

A purchaser of the product for which the inspection passing certificate has been issued by the issuance device can see from an entrustor template certificate, the device certificate, and the implementation information (with a signature) that the product is a manufactured object whose inspection has been conducted as a result of implementation of processing entrusted to the device concerned based on the intention by the worker (and the superintendent).

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that almost of all components are actually interconnected.

What is claimed is:

1. A processing right transfer system comprising:
a first terminal; and an implementation subject to perform processing,
the first terminal holding a first certificate indicating an entrustment content and an identifier of a transferee implementation subject to which a right to perform the processing is to be transferred, the entrustment content indicating an implementation condition for the processing and an implementation content of the processing, the first certificate being based on biometric information about an entrustor of the processing,
the implementation subject being configured to transmit information indicating whether the implementation condition is fulfilled and the identifier of the implementation subject to the first terminal, and
the first terminal being configured to:
conduct first certificate verification based on the entrustment content and the identifier indicated by the first certificate;
determine, if the first terminal determines in the first certificate verification and on the basis of the information received from the implementation subject that there is an implementation subject having transmitted the information indicating that the implementation condition is fulfilled, whether an identifier of the determined implementation subject conforms to the identifier indicated by the first certificate; and
transfer, to the implementation subject, the right to perform the processing indicated by the implementation content, on the basis of result of the first certificate verification.

2. The processing right transfer system according to claim 1, further comprising a second terminal,
wherein the first terminal holds a plurality of the first certificates,
wherein all the plurality of first certificates include respective public keys associated with the first certificates,
wherein the first terminal holds a secret key corresponding to each of the public keys,
wherein the first terminal is configured to:
acquire implementation information indicating the implementation content;
acquire a first certificate indicating the implementation content indicated by the implementation information from the plurality of first certificates;
conduct the first certificate verification based on the acquired first certificate;
add a signature to the implementation information on the basis of a secret key corresponding to a public key included in the acquired first certificate, if the first certificate verification has succeeded; and
transmit the implementation information given the signature and the acquired first certificate to the second terminal, and
wherein the second terminal is configured to verify the signature added to the implementation information on the basis of the public key included in the first certificate received from the first terminal.

3. The processing right transfer system according to claim 1,
wherein the first terminal holds:
a second certificate indicating an attribute of the entrustor and based on the biometric information; and
an entrustor condition about an attribute of an entrustor allowed to transfer the right to the implementation subject, and
wherein the first terminal is configured to:
conduct second certificate verification including verification whether the attribute indicated by the second certificate fulfills the entrustor condition; and
transfer the right to the implementation subject on the basis of result of the first certificate verification and result of the second certificate verification.

4. The processing right transfer system according to claim 3, wherein the attribute indicates at least one of a rating of the entrustor, work achievement of the entrustor, and a qualification of the entrustor.

5. The processing right transfer system according to claim 3, wherein the second certificate includes a region for storing a signature of a senior of the entrustor, and
wherein the first terminal is configured to conduct verification about the signature of the senior in the second certificate if the first terminal deterrmines in the second certificate verification that the attribute indicated by the second certificate does not fulfill the entrustor condition.

6. The processing right transfer system according to claim 1,
wherein a plurality of the implementation subjects is configured to be able to implement plural successive pieces of processing,
wherein a plurality of the entrustors corresponds to each of the implementation subjects, and
wherein the first terminal holds the first certificates each corresponding to a combination of processing belonging to the plural pieces of processing, an implementation subject belonging to the plurality of implementation subjects, and an entrustor belonging to the plurality of entrustors, and
wherein the first terminal is configured to:
conduct the first certificate verification based on any one of the first certificates; and
transfer a right to perform processing corresponding to the one first certificate to an implementation subject corresponding to the one first certificate, on the basis of result of the first certificate verification.

7. A processing right transfer method by a processing right transfer system,
the processing right transfer including: a first terminal; and an implementation subject to perform processing,
the first terminal holding a first certificate indicating an entrustment content and an identifier of a transferee implementation subject to which a right to perform the processing is to be transferred, the entrustment content indicating an implementation condition for the processing and an implementation content of the processing, the first certificate being based on biometric information about an entrustor of the processing,
the processing right transfer method comprising:
transmitting, by the implementation subject, information indicating whether the implementation condition is fulfilled and the identifier of the implementation subject to the first terminal;
conducting, by the first terminal, first certificate verification based on the entrustment content and the identifier indicated by the first certificate;
determining, by the first terminal, if the first terminal determines in the first certificate verification and on the basis of the information received from the implementation subject that there is an implementation subject having transmitted the information indicating that the implementation condition is fulfilled, whether an identifier of the determined implementation subject conforms to the identifier indicated by the first certificate; and
transferring, by the first terminal, to the implementation subject, the right to perform the processing indicated by the implementation content, on the basis of result of the first certificate verification.
